(19) United States
(12) Patent Application Publication
(10) Pub. No.: US 2019/0252786 A1
(43) Pub. Date: Aug. 15, 2019

(54) DEVICES AND METHODS FOR IMPLEMENTING MIMO IN METAL RING STRUCTURES USING TUNABLE ELECTRICALLY SMALL ANTENNAS

(71) Applicant: wiSpry, Inc., Irvine, CA (US)

(72) Inventor: Joungsub Shin, Irvine, CA (US)

(21) Appl. No.: 16/271,776

(22) Filed: Feb. 8, 2019

Related U.S. Application Data
(60) Provisional application No. 62/628,691, filed on Feb. 9, 2018.

(51) Int. Cl. H01Q 9/04; H01Q 5/335; H01Q 1/24; H01Q 21/00; H01Q 1/52

(52) U.S. Cl. CPC H01Q 9/0442; H01Q 5/335; H01Q 1/523; H01Q 21/0025; H01Q 1/243

(57) ABSTRACT

Devices and methods for implementing MIMO in metal ring structures using tunable electrically small antennas. In some embodiments, the metal ring structure includes a mobile device including electrically small antennas arranged on it, tunable band-stop circuits, wherein each of the electrically small antennas has a largest dimension that is substantially equal to or less than one-tenth of a length of a wavelength corresponding to a frequency within a communications operating frequency band. In some embodiments, the tunable electrically small antennas utilize parts of the metal ring structure of the mobile device as antenna radiators. The TESA are tunable for low-band frequencies between about 600 MHz-960 MHz. Additionally, the TESA have a wide bandwidth in high-band between about 1700 MHz-2700 MHz. In order to separate the TESA radiators from the rest of the metal ring structure, the radiators are connected by insulating material.

### CROSS-REFERENCE TO RELATED APPLICATION

The present application claims priority to U.S. Provisional Patent Application Ser. No. 62/628,691, filed Feb. 9, 2018, the entire disclosure of which is incorporated by reference herein.

### TECHNICAL FIELD

The subject matter disclosed herein relates generally to wireless antennas. More particularly, the subject matter disclosed herein relates to tunable electrically small antennas utilized for Multiple-Input and Multiple-Output (MIMO) applications in mobile devices.

### BACKGROUND

In radio technologies, multiple-input and multiple-output (MIMO) is a method for multiplying the capacity of a radio link using multiple transmission and receiving antennas to exploit multipath propagation. MIMO has become an essential element of wireless communication standards, including Wi-Fi, 3G, and 4G Long Term Evolution (4G LTE). Due to the ever-decreasing size of phones and the increasing data rate speed requirements, it is ideal, in some instances, to use electrically small antennas and utilize parts of the phone itself in the antenna structure. Some mobile phones use metal rings as part of the mobile phone structure and in some cases parts of the metal rings can be used as antenna radiators.

The subject matter of the present disclosure attempts to meet the technical demands of current and future communications standards and MIMO functionality by providing tunable electrically small antennas to mobile devices and utilizing the metal structures of the mobile devices as antenna radiators. In turn mobile device efficiency and performance is improved and material usage can be minimized.

### SUMMARY

In accordance with this disclosure, devices and methods are provided for implementing MIMO using tunable electrically small antennas (TESA) in mobile devices including those comprising a metal ring structure. In one embodiment, a mobile device is provided comprising: a plurality of electrically small antennas arranged on the mobile device; and a plurality of tunable band-stop circuits; wherein each of the plurality of electrically small antennas is in communication with at least one of the plurality of tunable band-stop circuits and every tunable band-stop circuit is connected to a signal node; wherein each of the plurality of electrically small antennas has a largest dimension that is substantially equal to or less than one-tenth of a length of a wavelength corresponding to a frequency within a communications operating frequency band; and wherein each of the plurality of tunable band-stop circuits is tunable to adjust a band-stop frequency.

In one aspect of the present disclosure, two TESA for MIMO are located on a first end of a mobile device or on a second end of the mobile device, wherein the first end is opposite the second end and the mobile device can comprise a metal ring structure. Both TESA are tunable for low-band operational frequencies between about 600 MHz-960 MHz. Additionally, both TESA have a wide bandwidth of operational frequencies in high-band between about 1700 MHz-2700 MHz. Moreover, the frequency range of the band-stop circuit is between the low-band operating frequency range and the high-band operating frequency range. In some embodiments, the tunable antennas may use parts of the metal ring structure as antenna radiators. In order to separate the TESA radiators from the rest of the metal ring structure, the radiators are connected by insulating material (e.g., plastic). Furthermore, there is insulating material between each antenna radiator and the upper part of the metal ring structure.

In some embodiments of the present disclosure, each TESA's radiation pattern of low band is tilted away from 0 degrees in opposite directions (e.g., tilted approximately 45 degrees in opposite directions) such that the radiation patterns are substantially decoupled (e.g., the angle between the two radiation patterns is between about 80 degrees and 100 degrees). Due to this angle, the antennas have a low correlation with each other and thus have a low Envelope Correlation Coefficient (ECC). The two antennas are symmetric in physical structure and electrical performance such that the gain imbalance of the two antennas is very low (e.g., about 0.5 dB or lower). In some embodiments, an ECC of the antennas is below 0.5.

In some embodiments, each of the antenna radiators are symmetric in structure. Each of the insulators separates the antenna radiators from the rest of the metal ring structure. Additionally, each of the antennas are coupled to band-stop circuits. Each of the band-stop circuits are separated from the bottom of the metal ring structure, i.e., the antenna radiators. Furthermore, each band-stop circuit comprises a variable capacitor.

In some embodiments, of the two TESA design, one TESA can be positioned at one location of the mobile device and a second TESA can be positioned at a second location which is different than the first location. For example and without limitation, one TESA can be positioned on one end of the mobile device and a second TESA can be positioned on a second end of the mobile device, where the second end is opposite the first end. In some embodiments, the design comprises three TESA, wherein two TESA are positioned on one end and a third positioned on a second end opposite the first end.

In accordance with another aspect of this disclosure, the mobile device comprises four TESA instead of two. In this configuration, there are two TESA at a first end of the mobile device and two TESA at a second end of the mobile device, with the second end substantially opposing the first end. In some embodiments, the antennas are tunable for low-band operating frequencies of between about 600 MHz-960 MHz and high-band operating frequencies of between about 1700 MHz and 2700 MHz, although those having ordinary skill in the art will recognize that the principles discussed herein can similarly be applied to antenna systems that are configured to operate at different frequencies. Additionally, an implementation using a metal ring structure comprises six metal components connected by insulators (e.g., plastic). The location of the TESA and band-stop circuits in the four-TESA configuration is similar to that of the two-TESA configuration in that all of the band-stop circuits are located away from the metal-ring structure, and parts of the metal-ring structure act as antenna radiators.

Although some aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present disclosure will be more readily understood from the following detailed description which should be read in conjunction with the accompanying, example figures that are given merely by way of explanatory and non-limiting example. The detailed description that follows this section references the example figures briefly described below.

FIGS. 1A, 1B and 1C illustrate a mobile device with a metal-ring structure employing the dual-TESA configuration. FIG. 2 illustrates a mobile device with a metal-ring structure employing the four-TESA configuration.

FIGS. 3A and 3B are circuit diagrams illustrating exemplary configurations for the tunable electrically small antennas according to embodiments of the presently disclosed subject matter.

FIGS. 4A and 4B are two graphs illustrating the S-parameters of the two antennas across a capacitance tuning range of between about 2 pF and 5 pF.

FIGS. 5A and 5B are two graphs illustrating the Farfield efficiency of the two antennas.

FIGS. 6A and 6B are two graphs illustrating a comparison between the S-parameters of one of the antennas and the envelope correlation coefficient of the antenna with a capacitance of about 2 pF.

FIGS. 7A and 7B are two plots illustrating the radiation patterns of the two TESA antennas when operating at a frequency of about 900 MHz.

FIGS. 8A, 8B and 8C illustrate close-up side views of the mobile device highlighting the insulator slit and two graphs illustrating the S-parameters of one of the antennas and efficiency of the antenna as its corresponding slit is altered from between about 5 mm and 1 mm.

FIGS. 9A, 9B and 9C illustrate close-up top views of the mobile device highlighting the ground spacing of one of the TESA and two graphs illustrating the S-parameters of one of the antennas and efficiency of the antenna as its corresponding ground spacing is altered from between about 10 mm and 4 mm.

FIGS. 10A, 10B and 10C illustrate close-up top views of the mobile device highlighting the ground spacing of the second TESA and two graphs illustrating the S-parameters of the second antenna and efficiency of the second antenna as its corresponding ground spacing is altered from between about 10 mm and 4 mm.

FIGS. 11A, 11B, 11C, 11D, 11E and 11F are six graphs illustrating the S-parameters of the four TESA antennas as well as their efficiency graphs.

FIGS. 12A and 12B are two graphs illustrating the S-parameters of the four TESA antennas with the capacitance set to its maximum.

### DETAILED DESCRIPTION

The present subject matter described herein provides devices and methods for implementing MIMO in mobile devices comprised of a metal ring structure using one or more tunable electrically small antenna systems, otherwise referred to as a TESA. Electrically small antennas are antennas which are generally much shorter (in terms of length, diameter, etc.) than the wavelength of the signal it is designed to transmit and/or receive. In some embodiments, TESA can have a largest dimension that is substantially equal to or less than one-tenth of a length of a wavelength corresponding to a low-band communications operating frequency in which the TESA operates. In some embodiments, for example, tunable antenna systems can be configured to be resonant at or about a desired high-band frequency (e.g., between about 1.7 GHz and 2.7 GHz). In addition, the systems can further be configured to be tunable to exhibit resonance at a frequency within a desired low-band operational frequency range (e.g., between about 600 MHz to 960 MHz, a range that include UMTS frequency bands B5, B8, B12, B13, B14, B17, and B71). Those of ordinary skill in the art will appreciate that the high-band resonating frequency range and low-band resonating frequency range discussed herein are for example purposes only and the design of the present antenna system can be configured and arranged to operate or communicate at higher or lower frequency bands.

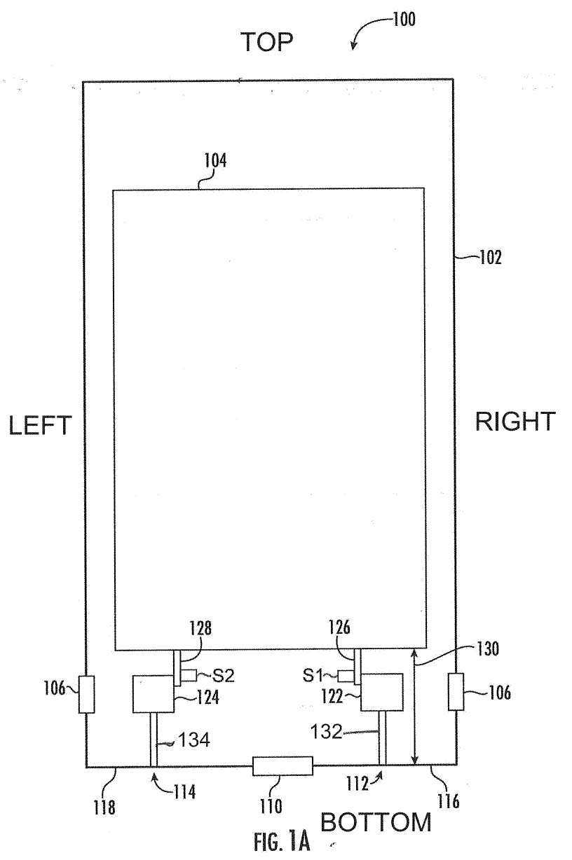

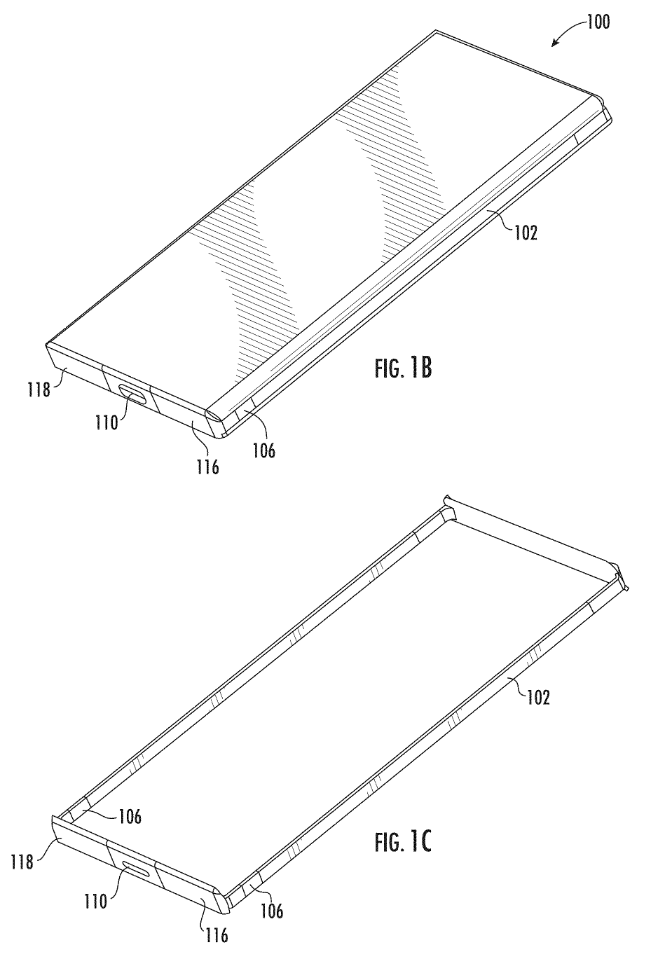

In one aspect of the present disclosure, FIG. 1A is a representation of a mobile device 100 implementing the dual-TESA for MIMO. In some embodiments, for the dual-TESA design, one TESA can be positioned at a first location of the mobile device and a second TESA can be positioned at a second location of the mobile device, where the second location is different than the first location. In the configuration shown in FIG. 1A, two TESA for MIMO are located, for non-limiting example, on the bottom end of the mobile device 100. However, in some embodiments, the two TESA antennas can be on the top end of the mobile device 100 or any other suitable location. In some embodiments, the first location and the second location are selected to optimally minimize antenna coupling and diversity of antenna radiation patterns of the first TESA and the second TESA.

Although the mobile device 100 is depicted in FIG. 1A and FIG. 2 as rectangular, it is envisioned that the mobile device 100 can be any suitable shape for a mobile device. Although the two TESA are described in FIG. 1A as being on the top or bottom of the mobile device 100, this is for non-limiting example and descriptive purposes only. In this discussion of the figures, top and bottom are used to only describe how the TESA appear in the drawing. With that being said, in some embodiments, the positioning and configuration of the TESA (regardless of the specific number used) can be chosen to optimally minimize antenna coupling and Envelope Correlation Coefficient (ECC) (described further hereinbelow), and/or to exhibit radiation patterns that are substantially decoupled. Furthermore, in some embodiments the positioning and configuration of the TESA can be chosen such that when the TESA are transmitting and receiving wireless signals, there is minimal signal interference between the TESA. For example without limitation, the two TESA could be at opposite ends of the mobile device 100, although as described in the four-TESA example below with respect to FIG. 2, the two TESA must be on the same side of the mobile device 100 (i.e., for example LEFT side or RIGHT side) to have a low ECC and/or antenna coupling. Alternatively, it should be understood that the particular embodiments in FIGS. 1A and 2 can for example comprise different geometries including the width (i.e., the length from the LEFT side to the RIGHT side) being greater than the height (i.e., the length from TOP to BOTTOM). In some embodiments, a plurality of TESA can be placed on a first end of the mobile device 100, and/or they can be placed on a second end, opposite the first end, of the mobile device 100. In some embodiments, an end of the mobile device 100 can be a corner of an edge of the mobile device 100. In some embodiments, two TESA can be arranged on two opposite corners of an edge of the mobile device 100.

In some embodiments, the plurality of TESA can be arranged, placed, positioned, or configured on the mobile device 100 such that a first of the plurality of electrically small antennas has a first radiation pattern and a second of the plurality of electrically small antennas has a second radiation pattern, the second radiation pattern being substantially decoupled from the first radiation pattern. In some embodiments, the plurality of TESA can be arranged, placed, positioned, or configured on the mobile device 100 such that a third of the plurality of electrically small antennas has a third radiation pattern (substantially the same as the second radiation pattern) and a fourth of the plurality of electrically small antennas has a fourth radiation pattern (substantially the same as the first radiation pattern), the fourth radiation pattern being substantially decoupled from the third radiation pattern. Those of ordinary skill in the art will appreciate that the concepts and designs discussed herein can be extended to other geometries of the mobile device 100 that might not be explicitly described herein.

In some embodiments, the mobile device 100, can be a mobile phone comprising a metal ring structure 102. In some embodiments, the metal ring structure 102 is a structure that is already built in to the mobile device 100 and is not added to the mobile device 100 at some later time. In some other embodiments, the mobile device 100 can be a tablet PC, personal data assistant (PDA), or other suitable mobile communications device. In some embodiments, the metal ring structure 102 is disposed within the mobile device 100. Additionally, in some embodiments the mobile device 100 comprises a printed circuit board (PCB) ground plane 104. In some embodiments, first band-stop circuit 122 is connected to the PCB ground plane 104 via first connection circuit 126. Second band-stop circuit 124 is connected to the PCB ground plane 104 via second connection circuit 128. In some embodiments, first band-stop circuit 122 and/or second band-stop circuit 124 can be mounted or arranged on PCB (not shown in this illustration).

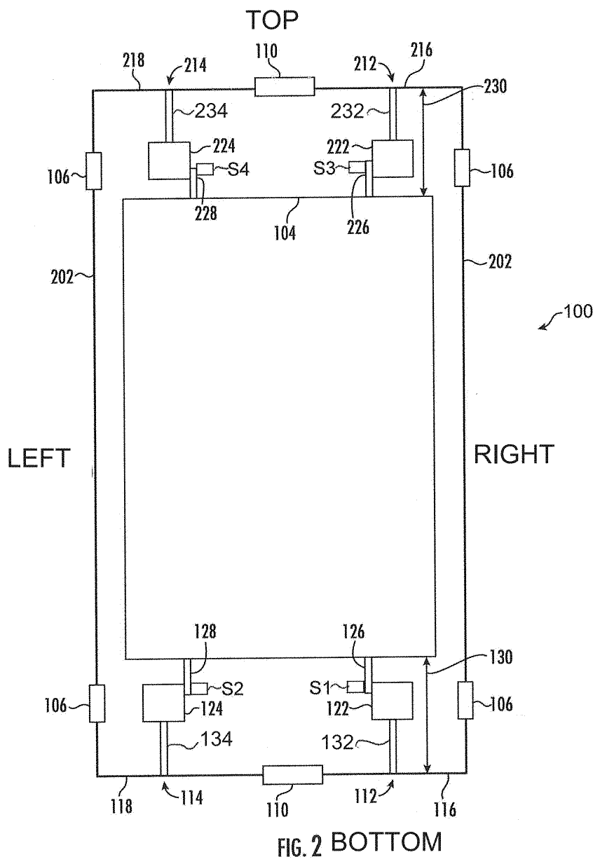

As illustrated in FIG. 1A, first radiator connection circuit 132 connects the first antenna radiator 116 to the first band-stop circuit 122, and second radiator connection circuit 134 connects the second antenna radiator 118 to the second band-stop circuit 124. As illustrated below in FIG. 3A and FIG. 3B, in some embodiments, first radiator connection circuit 132 and second radiator connection circuit 134 can comprise an electrostatic discharge protector such as for example capacitor C4. Furthermore, in some embodiments, first radiator connection circuit 132 and second radiator connection circuit 134 can comprise a wire to the antenna radiator 116.

In some embodiments, first TESA 112 and second TESA 114 are symmetric in physical structure and electrical performance, so that the gain imbalance of first TESA 112 and second TESA 114 is very low (e.g., about 0.5 dB or less). In some embodiments, first TESA 112 comprises first band-stop circuit 122 and a first antenna radiator 116, which in some embodiments, comprises a portion of the metal ring structure 102. Furthermore, in some embodiments, first antenna radiator 116 can be electrically insulated from the rest of the metal ring structure 102 by the insulator 106. In some embodiments, the insulator 106 can be comprised of, for example and without limitation, plastic, rubber, or any other suitable insulator. Similarly, in some embodiments, second TESA 114 comprises second band-stop circuit 124 and a second antenna radiator 118, which can likewise comprise a portion of the metal ring structure 102. In some embodiments, an antenna radiator like that of the first antenna radiator 116 and/or the second antenna radiator 118, is a radiating component of an antenna. Moreover, second antenna radiator 118 can, in some embodiments, be electrically insulated from the rest of the metal ring structure 102 by the insulator 106. In some embodiments, first antenna radiator 116 and second antenna radiator 118 are insulated from each other by composite insulator 110. In some embodiments the composite insulator 110 may comprise metallic components, which may in some embodiments be grounded. In some embodiments, the first connection circuit 126 and second connection circuit 128 are connected to first signal node S1 and second signal node S2 respectively, that feeds the antennas. Although FIG. 1A depicts the first signal node S1 connected to the first connection circuit 126 and the second signal node S2 connected to the second connection circuit 128, in some embodiments, the first signal node S1 can be connected directly to the first band-stop circuit 122 and the second signal node S2 can be connected to the second band-stop circuit 124. In some embodiments, any signal node could be a coaxial cable input into the antenna circuit. In some other embodiments, any signal node could be directly connected to some other circuitry such for example a radio frequency (RF) front end. In some embodiments, the first band-stop circuit 122 and second band-stop circuit 124 are tunable to adjust a band-stop frequency of the first TESA 112 and the second TESA 114 as well as the low-band resonating frequency of the first TESA 112 and the second TESA 114 respectively. Unless otherwise specified herein, the various components including for example the band stop circuits and connection circuits can be arranged on a PCB of the mobile device 100 (not specifically shown in the figure).

In order to ensure the efficiency of first TESA 112 and second TESA 114, in some embodiments, both first band-stop circuit 122 and second band-stop circuit 124 are positioned away from the edges of the mobile device 100. Additionally, in some embodiments, the PCB ground plane 104 can be positioned within the mobile device 100 far enough away from the metal ring structure 102 and/or the antenna radiators and/or the first TESA 112 and second TESA 114 such that the efficiency of the first TESA 112 and second TESA 114 is maintained. For example and without limitation, the PCB ground plane 104 can have a ground spacing 130 of between about 4 mm and 10 mm the first antenna radiator 116 and/or the second antenna radiator 118. In some embodiments, for example and without limitation, the PCB ground plane 104 can have a ground spacing 130 of about 6mm. Additionally, first antenna radiator 116 and second antenna radiator 118 each have an electrically small length (i.e., for example, a largest dimension which is substantially equal to or less than one-tenth of the wavelength—λ/10, where λ is wavelength—corresponding to a frequency of low-band operation of the antenna.) designed to radiate at a desired low-band frequency. For example and without limitation, n some embodiments, the desired low-band radiating frequency can range between about 600 MHz and 960 MHz. In some embodiments, the lengths of the first antenna radiator 116 and the second antenna radiator 118 are substantially equal to or less than one-tenth of the length of the wavelength (i.e., λ/10, where λ is wavelength) corresponding to a frequency of low-band operation within a communications operating frequency band. For example and without limitation, in some embodiments, the first antenna radiator 116 and the second antenna radiator 118 have a length of about 24 mm, which corresponds to operation in desired low-band frequencies down to about 700 MHz.

Moreover, insulators 106 have a length selected to maximize radiation efficiency and minimize antenna coupling and the Envelope Correlation Coefficient (ECC) between the antennas. The ECC quantifies the independence of two antenna's radiation patterns with respect to one another. So, if one antenna was completely horizontally polarized and a second antenna was perpendicular to the first antenna, i.e., completely vertically polarized, the first antenna and the second antenna would have a correlation of zero. Alternatively, assuming that the first antenna (of any polarization) only radiated energy toward the ground and the second antenna (of any polarization) only radiated energy toward the sky, the two antennas would also have an ECC of 0. Hence, the ECC takes into account the antenna's radiation pattern shape, polarization, and even the relative phase of the fields between the two antennas. For example and without limitation, in some embodiments, the length of the insulators 106 is between about 3 mm and 5 mm.

In some embodiments, both of first TESA 112 and second TESA 114 can be configured to be tunable to exhibit resonance at or about a desired low-band frequency ranging between about 600 MHz and 960 MHz, a range that includes Universal Mobile Telecommunications System (UMTS) bands B5, B8, B12, B13, B14, B17, and B71. In some embodiments, first TESA 112 and second TESA 114 are configured such that the radiation patterns are substantially perpendicular to each other, i.e., such that the radiation patterns create an angle of between about 80 degrees and 100 degrees with respect to each other.

FIG. 1B is an isometric view of the mobile device 100. FIG. 1B illustrates how the mobile device 100 appears with the metal ring structure 102, the insulator 106, the composite insulator 110, the first antenna radiator 116, and the second antenna radiator 118. Similarly, FIG. 1C is an isometric view of the metal ring structure 102 without the rest of the mobile device 100, but does include the other components discussed above from FIG. 1B.

In another embodiment of the present disclosure, FIG. 2 illustrates a mobile device 100, like the one in FIG. 1A above, but with four TESA instead of two. The discussion above regarding the shape of the mobile device 100 and the positioning of the TESA applies to this example as well. In some embodiments, first TESA 112, second TESA 114, third TESA 212, and fourth TESA 214 in FIG. 2 are all symmetrical in structure and electrical performance. First TESA 112 and second TESA 114 are substantially the same structure and have substantially the same connections as in FIG. 1 above. First TESA 112 and second TESA 114 are arranged at a first end of the mobile device 100, for example and without limitation at the bottom or the top of the mobile device 100. Third TESA 212 and fourth TESA 214 are connected in a similar manner but arranged at a second end of the mobile device 100, for example and without limitation, opposite the first end at the top or the bottom of the mobile device 100. Third band-stop circuit 222 is connected to the PCB ground plane 104 via third connection circuit 226. Fourth band-stop circuit 224 is connected to the PCB ground plane 104 via fourth connection circuit 228. In some embodiments, the first connection circuit 126, the second connection circuit 128, the third connection circuit 226 is connected to a third signal node S3, and the fourth connection circuit 228 is connected to a fourth signal node S4 that feed the antenna. In some embodiments, as illustrated in FIG. 2, first radiator connection circuit 132 connects the first antenna radiator 116 to the first band-stop circuit 122, second radiator connection circuit 134 connects the second antenna radiator 118 to the second band-stop circuit 124, third radiator connection circuit 232 connects the third antenna radiator 216 to the third band-stop circuit 222, and fourth radiator connection circuit 234 connects the fourth antenna radiator 218 to the fourth band-stop circuit 224. As illustrated below in FIG. 3A and FIG. 3B, in some embodiments, third radiator connection circuit 232 and fourth radiator connection circuit 234 can comprise an electrostatic discharge protector such as for example capacitor C4. Furthermore, in some embodiments, third radiator connection circuit 232 and fourth radiator connection circuit 234 can comprise a wire or short circuit.

In some embodiments, the first band-stop circuit, 122 the second band-stop circuit 124, the third band-stop circuit 222 is connected to a third signal node S3, and the fourth band-stop circuit 224 is connected to a fourth signal node S4. In some embodiments, the first band-stop circuit 122, the second band-stop circuit 124, the third band-stop circuit 222, and the fourth band-stop circuit 224 are tunable to adjust a band-stop frequency of the first TESA 112, the second TESA 114, the third TESA 212, and the fourth TESA 214, respectively.

As discussed above, first TESA 112 and second TESA 114 are structured and connected in substantially the same manner as described in FIG. 1 above. Third TESA 212 is coupled to third band-stop circuit 222. Third TESA 212 is also connected to a third antenna radiator 216, which in some embodiments, comprises a portion of the metal ring structure 202. However, third antenna radiator 216 can be electrically insulated from the rest of the metal ring structure 202 by the insulator 106. Similarly, fourth TESA 214 is coupled to fourth band-stop circuit 224. Fourth TESA 214 is connected to a fourth antenna radiator 218, which can likewise comprise a portion of the metal ring structure 202. However, fourth antenna radiator 218 can be electrically insulated from the rest of the metal ring structure 202 by the insulator 106. In some embodiments, third antenna radiator 216 and fourth antenna radiator 218 are insulated from each other by composite insulator 110.

In some embodiments, first TESA 112, second TESA 114 are configured such that the radiation patterns are substantially perpendicular to each other, i.e., such that the radiation patterns create an angle of between about 80 degrees and 100 degrees with respect to each other. In some embodiments, third TESA 212 and fourth TESA 214 are configured such that the radiation patterns are substantially perpendicular to each other, i.e., such that the radiation patterns create an angle of between about 80 degrees and 100 degrees with respect to each other. In some embodiments, third TESA 212 has a radiation pattern that is substantially the same as a radiation pattern of the second TESA 114. In some embodiments, fourth TESA 214 has a radiation pattern that is substantially the same as a radiation pattern of the first TESA 112.

In order to ensure the efficiency of third TESA 212 and fourth TESA 214, both the third band-stop circuit 222 and the fourth band-stop circuit 224 are positioned away from the second end of the mobile device 100. Additionally, as discussed above with respect to FIG. 1A, in some embodiments, the PCB ground plane 104 is positioned within the mobile device 100 far enough away from the metal ring structure 102 such that the efficiency of the third TESA 212 and fourth TESA 214 is maintained. For example and without limitation, the PCB ground plane 104 can have a ground spacing 230 of between about 4 mm and 10 mm from the metal ring structure 102. In some embodiments, for example and without limitation, the PCB ground plane 104 can have a ground spacing 230 of about 6 mm from the metal ring structure 102. Additionally, third antenna radiator 216 and fourth antenna radiator 218 each have an electrical length designed to radiate at a desired frequency. In some embodiments, the desired low-band radiating frequency can range between about 600 MHz and 960 MHz. The lengths of the third antenna radiator 216 and the fourth antenna radiator 218 are approximately one tenth the length of the wavelength of the greatest frequency of low-band operation. For example and without limitation, in some embodiments, the length of the third antenna radiator 216 and the fourth antenna radiator 218 have a length of about 24 mm, corresponding to a desired a low-band frequency of about 700 MHz. Moreover, insulators 106 have a length selected to maximize radiation efficiency. For example and without limitation, in some embodiments, the insulators 106 have lengths of between about 3 mm and 5 mm.

In some embodiments, first TESA 112 and second TESA 114 are configured to be tunable to exhibit resonance at or about low, mid, and high-band frequencies. In some embodiments, third TESA 212 and fourth TESA 214 are configured to be tunable to exhibit resonance at or about mid and high-band frequencies. This four-TESA configuration in mobile device 100 has been scaled up from the dual-TESA in FIG. 1A to reach 600 MHz while keeping good high-band performance. Therefore, in some embodiments, the group of four TESA can be tuned to a low band resonance of a range between about 600 MHz to 960 MHz. In addition, the centered metal ring structure 202 has low-band efficient impacts of around 1 dB. Furthermore, in some embodiments, first TESA 112 and second TESA 114 are configured such that there is a low Envelope Correlation Coefficient (ECC) between them. For example and without limitation, in some embodiments of the present disclosure, the ECC between the first TESA 112 and the second TESA 114 is below about 0.5. Moreover, in some embodiments, third TESA 212 and fourth TESA 214 are configured such that there is a low ECC between them as well. For example and without limitation, in some embodiments, the ECC between the third TESA 212 and the fourth TESA 214 is below about 0.5. Furthermore, in some embodiments, TESA which are on the same long side (i.e., for example both on the LEFT side or both on the RIGHT side) have a low ECC with each other. For example and without limitation, in some embodiments, first TESA 112 and third TESA 212 have a low ECC of below about 0.5 and second TESA 114 and fourth TESA 214 have a low ECC of below about 0.5.

In some embodiments, the mobile device 100 comprises a plurality of reactive circuit elements coupled between a respective one of the plurality of tunable band-stop circuits and the signal node, each of the plurality of reactive circuit elements having a reactance selected to achieve a system resonance for each of the plurality of tunable band-stop circuits and each of the electrically small antennas at a desired low frequency band within the communications operating frequency band below the band-stop frequency. In some embodiments, each of the plurality of reactive circuit elements comprises an inductor connected in a shunt arrangement with a first terminal of the inductor being connected between one of the tunable band-stop circuits and the first signal node S1 and a second terminal of the inductor being connected to a ground. In some embodiments, for example and without limitation, the first portion of the plurality of reactive circuit elements is equivalent to the first connection circuit 126 described in FIG. 1A and FIG. 2 above. In some embodiments, for example and without limitation, the second portion of the plurality of reactive circuit elements is equivalent to the second connection circuit 128 described in FIG. 1A and FIG. 2 above. The material above is discussed in further detail below in the discussion of FIGS. 3A and 3B.

In some embodiments, the mobile device 100 comprises a plurality of electrostatic discharge protection capacitors wherein each of the plurality of electrostatic discharge protection capacitors is connected between a respective one of the electrically small antennas and a respective one of the tunable band-stop circuits. In some embodiments, the mobile device 100 comprises a plurality of bandwidth control capacitors wherein each of the plurality of bandwidth control capacitors is connected between one of the plurality of tunable band-stop circuits and the signal node, each of the bandwidth control capacitors having a series capacitance selected to achieve a desired bandwidth of a desired high frequency band within the communications operating band above the band-stop frequency. The material above is discussed in further detail below in the discussion of FIGS. 3A and 3B.

FIGS. 3A and 3B illustrate circuit diagrams of exemplary configurations for tunable antenna systems and matching networks used on the mobile device 100 from FIG. 1A and mobile device 100 from FIG. 2, according to embodiments of the presently disclosed subject matter. FIGS. 3A and 3B are example configurations of the reactive circuit elements and electrostatic discharge protection elements discussed hereinabove. FIG. 3A includes possible circuit elements and their configuration for the matching topology of the first TESA 112 described above. Although in this embodiment, first TESA 112 is used for example purposes, those of ordinary skill in the art will appreciate that the circuitry described hereinbelow can be used for any or all of second TESA 114, third TESA 212, or fourth TESA 214. FIG. 3B includes circuit elements and their configuration for a matching topology of the first TESA 112 in an embodiment of the present disclosure. Although in this embodiment, first TESA 112 is used for example purposes, those of ordinary skill in the art will appreciate that the circuitry described hereinbelow can be used for any or all of second TESA 114, third TESA 212, or fourth TESA 214. FIG. 3A illustrates that in some embodiments, the first antenna radiator 116 is connected in series with capacitor C4, which acts as an electrostatic discharge protector for the first TESA 112. In some embodiments, capacitor C4 then connects to first band-stop circuit 122 comprising variable capacitor C1, inductor L3, and capacitor C5. In some embodiments, variable capacitor C1, inductor L3, and capacitor C5 are connected in parallel with each other. In some embodiments, variable capacitor C1 has a variable capacitance and is tunable to control the impedance of the first TESA 112. In some embodiments, capacitor C5 is an optional capacitor with a fixed capacitance to increase the minimum capacitance of variable capacitor C1. In some embodiments, inductor L3 has a set inductance sufficient to act as a band-stop frequency control of the first TESA 112. In some embodiments, variable capacitor C1 can comprise for example and without limitation, one or more banks of tunable capacitors with a high Q factors and a large ratio between a maximum tunable capacitance and minimum tunable capacitance of the tunable capacitors. In some embodiments, variable capacitor C1 can comprise one or more banks of variable capacitors selected from the group consisting of a micro-electro-mechanical systems (MEMS) variable capacitor, a semiconductor switch-based variable capacitor, a Barium Strontium Titanate (BST) variable capacitor, or a varactor diode. In some embodiments, variable capacitor C1 can comprise one or more banks of MEMS variable capacitors, which would likely provide the highest performance for the circuit.

Next, in some embodiments, the first band-stop circuit 122 connects to a resonance control circuit or first connecting circuit 126 comprised of inductor L1, capacitor C2, and capacitor C3. In some embodiments, inductor L1 is a shunt inductor and has a set inductance sufficient to act as a low-band resonance control of the first TESA 112. In some embodiments, L1 comprises a first terminal being connected between the first band-stop circuit 122 and the first signal node S1 and second terminal being connected to ground. In some embodiments, capacitor C2 is an optional capacitor with a set capacitance sufficient to act as a high band bandwidth control of the first TESA 112. And in some embodiments, capacitor C3 has a set capacitance sufficient to act as a high band resonance control for the first TESA 112.

In some aspects, the embodiment illustrated in FIG. 3B is a more specific version of that illustrated in FIG. 3A. In some embodiments, the first TESA 112 comprises first antenna radiator 116 connected to a first band-stop circuit 122 comprising inductor L3 and variable capacitor C1. In some embodiments, with respect to the first band-stop circuit 122, inductor L3 and variable capacitor C1 are connected in parallel with each other. In some embodiments of the present disclosure, variable capacitor C1 has a variable capacitance of between about 0.3 pF to 2.9 pF. In some embodiments the fixed capacitor C5, shown in FIG. 3A, can be connected in parallel with the variable capacitor C1 to increase the overall capacitance of the first band-stop circuit 122. In some embodiments, the fixed capacitor C5 has a selected capacitance such that the combined capacitance of the first band-stop circuit 122 is between about 2 pF and 5 pF. In some embodiments, the fixed capacitor C5 has a selected capacitance of between about 1.7 pF to 2.1 pF. In some embodiments, the fixed capacitor has a selected capacitance of about 1.7 pF. In some embodiments, inductor L3 has a fixed inductance of between about 6 nH and 7 nH. In some embodiments, inductor L3 has a fixed inductance of about 6.3 nH. In other embodiments, inductor L3 has a fixed inductance of about 6.8 nH. Additionally, first TESA 112 comprises a resonance control circuit or first connection circuit 126 comprising inductor L1, capacitor C2, and capacitor C3. In some embodiments, the capacitance of the capacitor C2 is selected to achieve a desired minimum capacitance of the first tunable band-stop circuits 122. In some embodiments, inductor L1 has a fixed inductance of between about 5 nH and 7 nH. In some embodiments, inductor L1 has a fixed inductance of about 5.6 nH. In other embodiments, inductor L1 has a fixed inductance of about 6.8 nH. In some embodiments, capacitor C3 has a capacitance of between about 1 pF and 1.5 pF, and capacitor C2 has a capacitance of between about 0 pF and 8 pF. In some embodiments, for example and without limitation, capacitor C3 has a capacitance of about 1.0 pF. In some embodiments, for example and without limitation, capacitor C3 has a capacitance of about 1.2 pF. In some embodiments, for example and without limitation, capacitor C2 has a capacitance of about 0 pF. In some embodiments, for example and without limitation, capacitor C2 has a capacitance of about 7.5 pF.

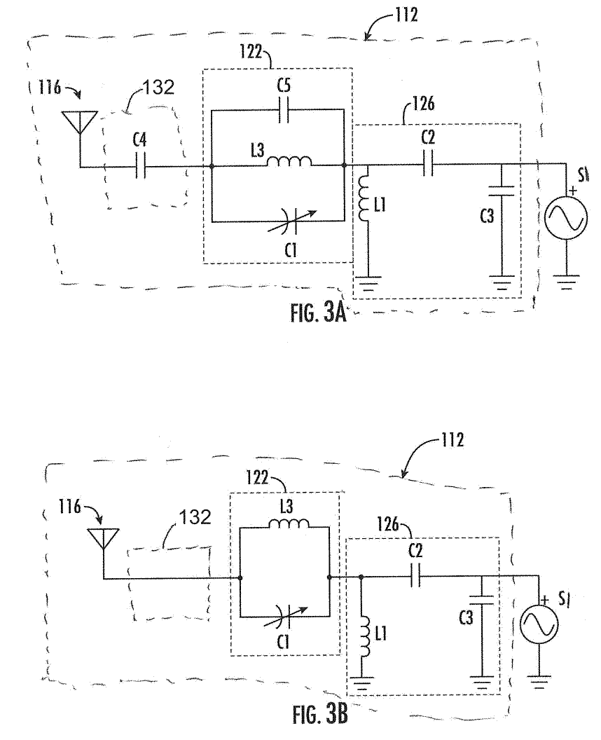

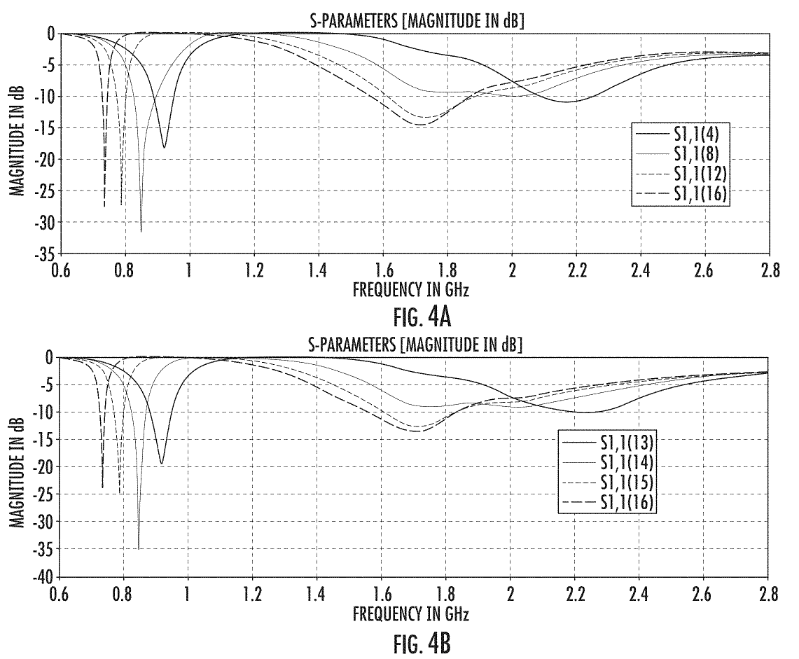

FIG. 4A is a graph illustrating the S-parameters of first TESA 112 with the capacitance of capacitor C1 ranging from between about 2 pF to about 5 pF. FIG. 4B is a graph illustrating the S-parameters of second TESA 114 with the capacitance of capacitor C1 ranging from between about 2 pF to about 5 pF.

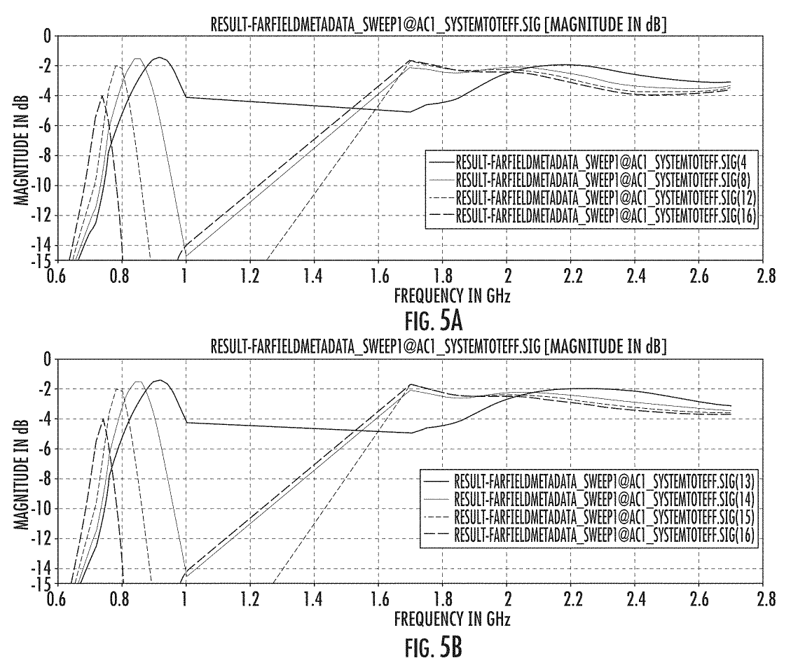

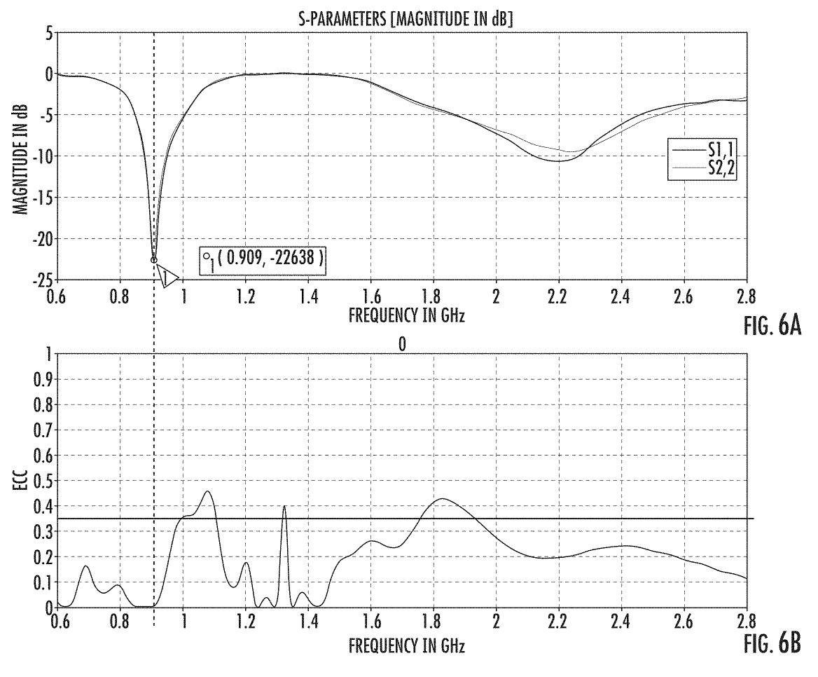

FIG. 5A is a graph illustrating the farfield efficiency data of first TESA 112. FIG. 5B is a graph illustrating the farfield efficiency data of second TESA 114. FIG. 6A is a graph illustrating the S-parameters of the first TESA 112 and second TESA 114. FIG. 6B, directly under and in-line with FIG. 6A, is a graph illustrating the envelope correlation coefficient of the antenna system when the capacitance of capacitor C1 is set to 2 pF.

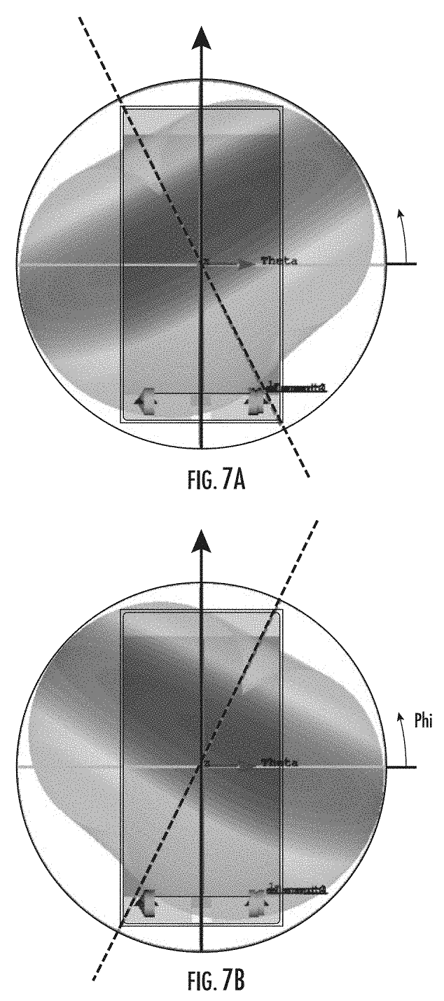

FIGS. 7A and 7B illustrate that, in some embodiments, first TESA 112 and second TESA 114 exhibit different radiation patterns during operation in low-band frequencies. In some embodiments, first TESA 112 and second TESA 114 are configured such that the radiation patterns are substantially perpendicular to each other, i.e., such that the radiation patterns create an angle of between about 80 degrees and 100 degrees with respect to each other. In some embodiments, first TESA 112 and second TESA 114 are configured such that the radiation patterns are substantially perpendicular to each other during operation in low-band frequencies, i.e., such that the radiation patterns create an angle of between about 80 degrees and 100 degrees with respect to each other. Thus, first TESA 112 and second TESA 114 have a low correlation with each other and can achieve a low ECC of below 0.5 in both low and high band frequencies.

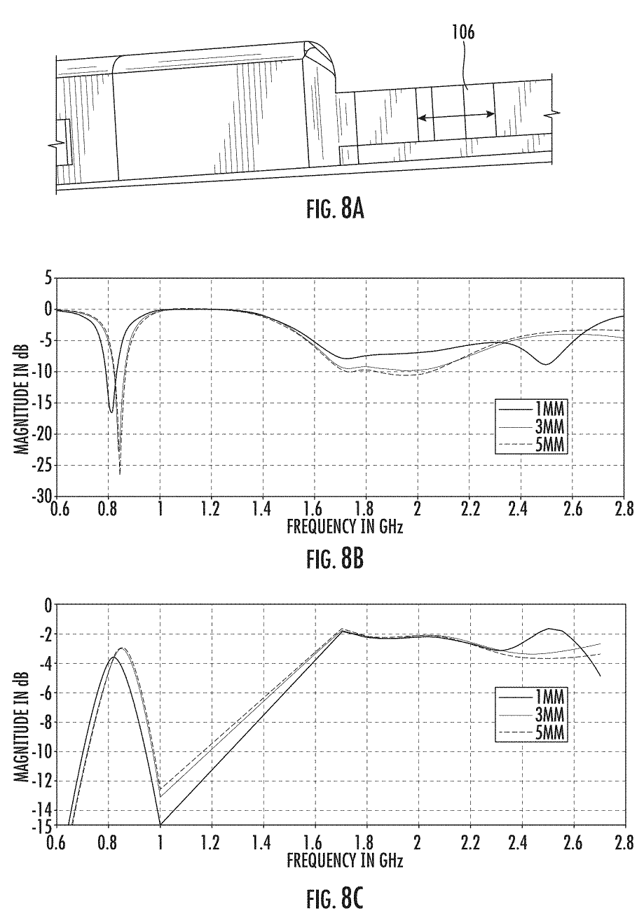

FIG. 8A is a side view of a portion of the mobile device 100 that includes insulator 106. The insulator 106 is configured to insulate the antenna radiators from the remainder of the metal ring structure 102. In some embodiments, the size or length of the insulator 106 can be selected to achieve a desired central operating frequency (optimal radiation frequency) and efficiency of the TESA and minimize ECC and/or coupling. FIGS. 8B and 8C are two graphs illustrating the S-parameters and efficiency, respectively, of the first TESA 112 when the insulator 106 length is changed from about 1 mm to about 3 mm, and finally to about 5 mm. As illustrated by the graph in FIG. 8C, when the insulator 106 length is about 3 mm or about 5 mm, the response is about the same. However, when the insulator 106 is changed to 1 mm in length, this spacing is too small to keep the best performance.

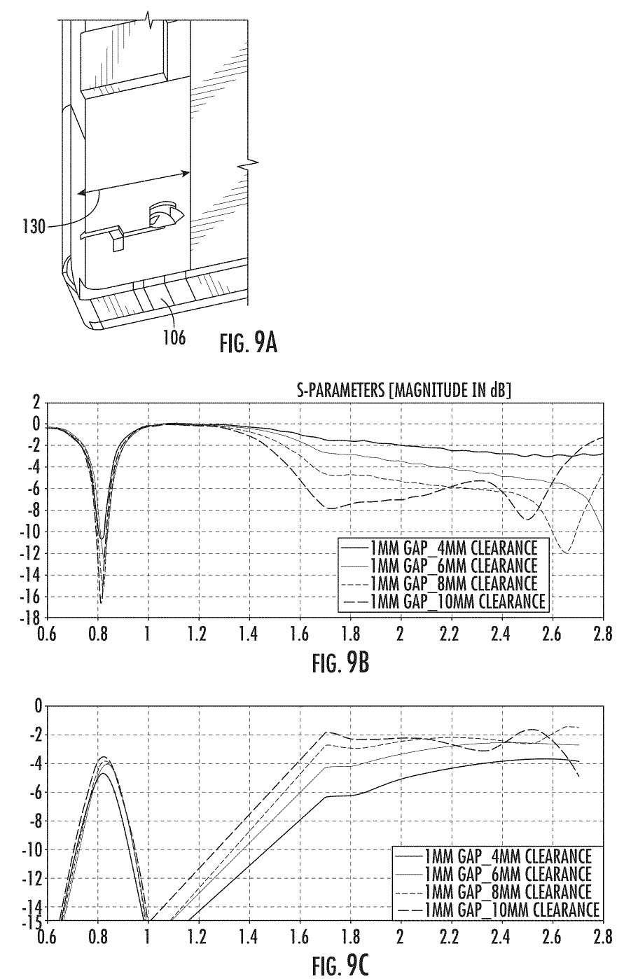

FIG. 9A is a top view of an edge of the mobile device 100 highlighting the ground spacing 130. Like the insulator 106 discussed above, the ground spacing 130 can be selected to further achieve a desired efficiency of the TESA. FIGS. 9B and 9C are two graphs illustrating the S-parameters and efficiency, respectively, of the first TESA 112 when the ground spacing 130 is changed from about 4 mm to about 6 mm to about 8 mm, and finally to about 10 mm. As illustrated by the graph in FIG. 9C, the efficiency is slightly degraded up to a ground spacing 130 of about 6 mm, but 4 mm has a big drop in both low and high frequencies.

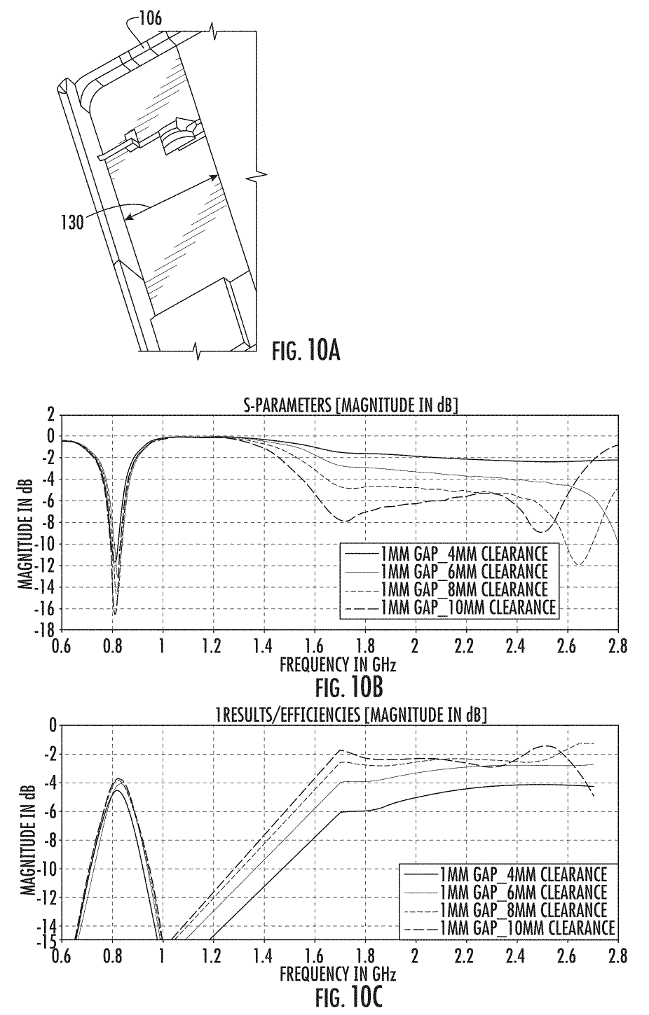

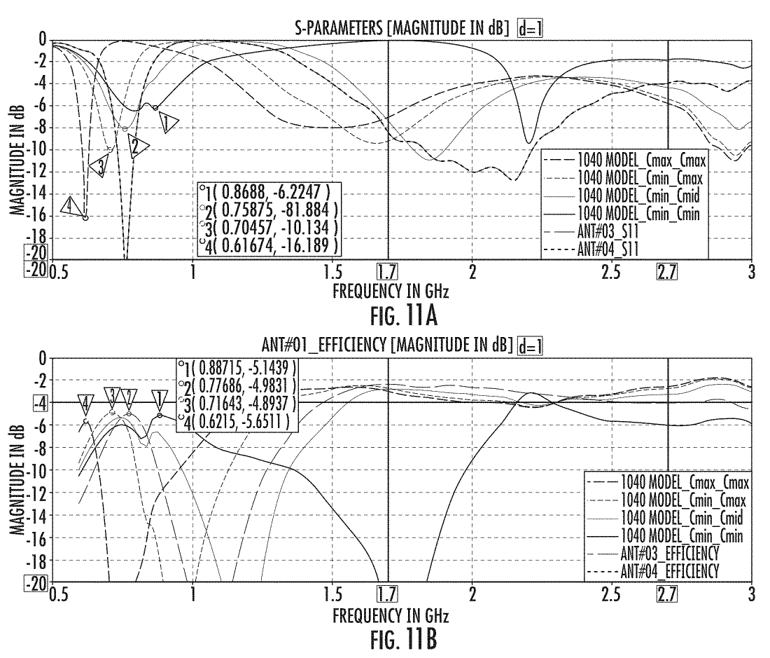

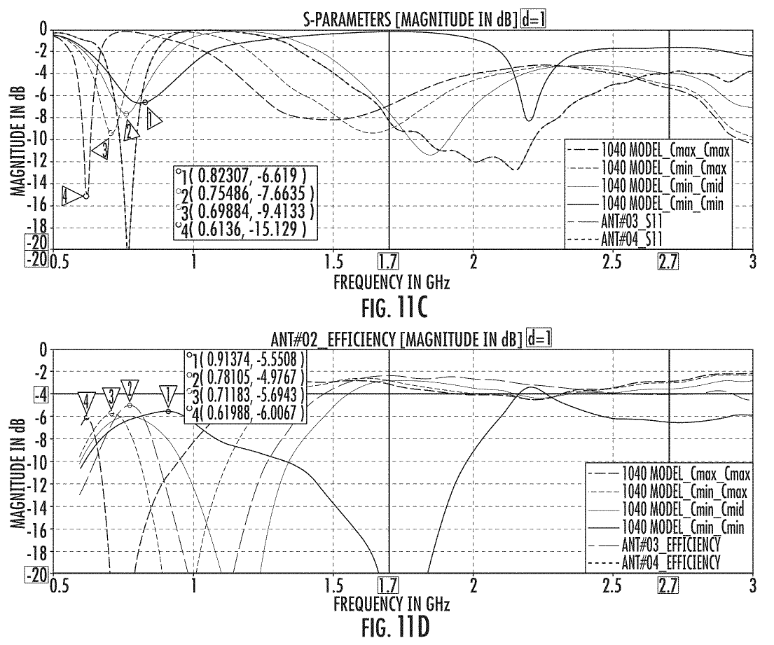

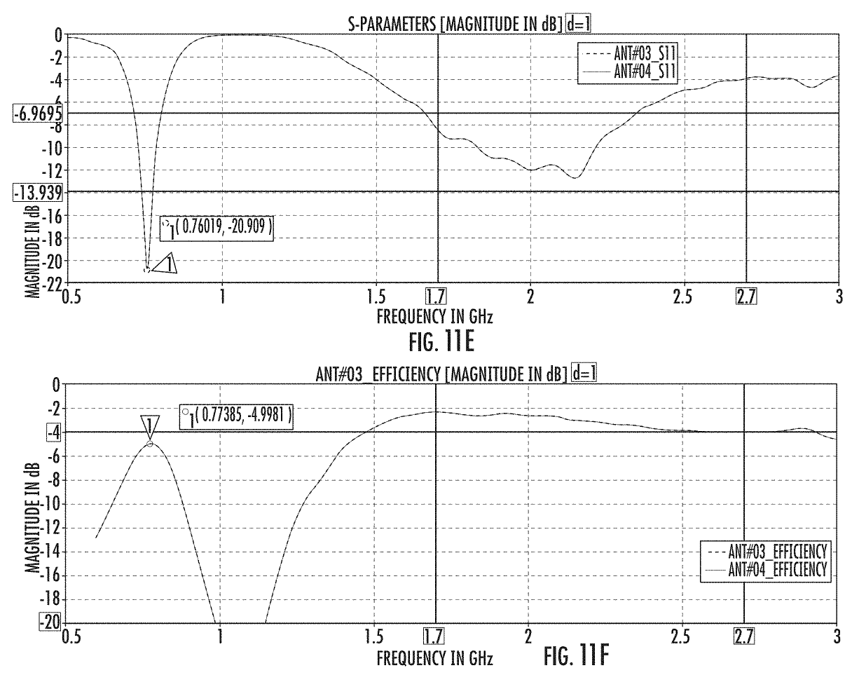

FIG. 10A is a top view of an edge of the mobile device 100 highlighting the ground spacing 130. FIGS. 10B and 10C are two graphs illustrating the S-parameters and efficiency, respectively, of the second TESA 114 when the ground spacing 130 is changed from about 4 mm to about 6 mm to about 8 mm, and finally to about 10 mm. As illustrated by the graph in FIG. 10C, the efficiency is slightly degraded up to a ground spacing 130 of about 6mm, but 4 mm has a big drop in both low and high frequencies. FIGS. 11A and 11B are graphs illustrating the S-parameters and the efficiency of the first TESA 112 in the quad-TESA configuration described above from FIG. 2. FIGS. 11C and 11D are graphs illustrating the S-parameters and the efficiency of the second TESA 114 in the quad-TESA configuration described above from FIG. 2. FIGS. 11E and 11F are graphs illustrating the S-parameters and the efficiency of the third TESA 212 and the fourth TESA 214 in the quad-TESA configuration described above from FIG. 2. As shown in FIGS. 11E and 11F, the S-parameters and efficiency of the two antennas is very similar.

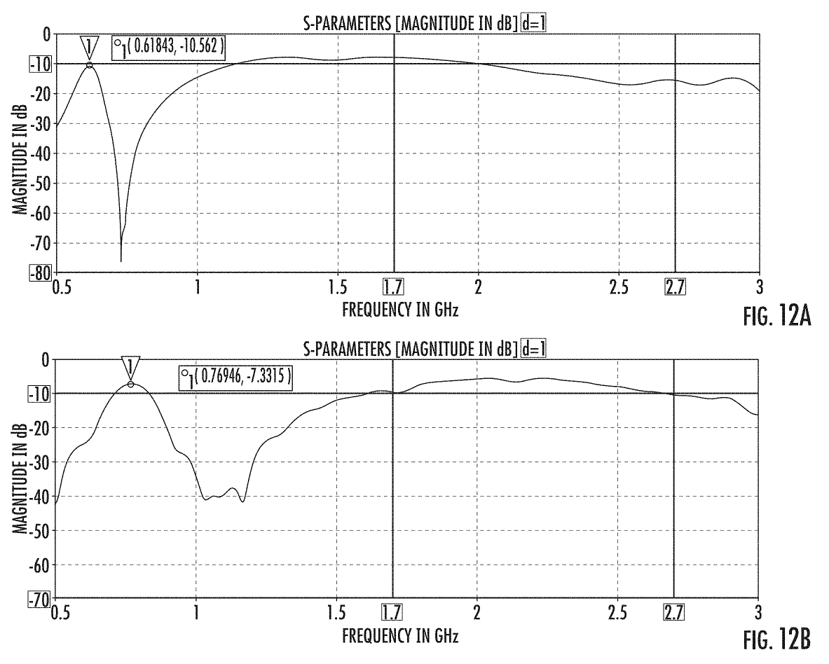

FIG. 12A is a graph illustrating the S-parameters and isolation of the second TESA 114 and the first TESA 112 from the quad-TESA described in FIG. 2 above. In this graph, the variable capacitor C1 has its capacitance set to a maximum of 5 pF. FIG. 12B is a graph illustrating the S-parameters and isolation of the fourth TESA 214 and the third TESA 212 from the quad-TESA described in FIG. 2 above. In this graph, the variable capacitor C1 has its capacitance set to a maximum of 5 pF.

Those of ordinary skill in the art will appreciate that the embodiments described above can, for example and without limitation, comprise more than four TESA. Additionally, those of ordinary skill in the art will appreciate that the more than four TESA can be arranged around the mobile device 100 such that all of the more than four TESA can fit on the metal ring structure 102.

The present subject matter can be embodied in other forms without departure from the spirit and essential characteristics thereof. The embodiments described therefore are to be considered in all respects as illustrative and not restrictive. Although the present disclosure has been described in terms of certain embodiments, other embodiments that are apparent to those of ordinary skill in the art are also within the scope of the present disclosure.

What is claimed is:

1. A mobile device comprising:
a plurality of electrically small antennas on the mobile device; and
a plurality of tunable band-stop circuits;
wherein each of the plurality of electrically small antennas is in communication with at least one of the plurality of tunable band-stop circuits and every tunable band-stop circuit is connected to a signal node;
wherein each of the plurality of tunable band-stop circuits is tunable to adjust a band-stop frequency within a frequency range above a low-band communications operating frequency range and below a high-band communications operating frequency range of the plurality of electrically small antennas; and
wherein each of the plurality of electrically small antennas has a largest dimension that is substantially equal to or less than one-tenth of a length of a wavelength corresponding to a frequency within the low-band communications operating frequency range that is below the band-stop frequency.

2. The mobile device of claim 1, wherein a first of the plurality of electrically small antennas has a first radiation pattern and a second of the plurality of electrically small antennas has a second radiation pattern, the second radiation pattern being substantially decoupled from the first radiation pattern.

3. The mobile device of claim 1, wherein a first of the plurality of electrically small antennas and a second of the plurality of electrically small antennas are substantially identical in physical structure and electrical performance such that a gain imbalance of the first of the plurality of electrically small antennas and the second of the plurality of electrically small antennas is about 0.5 dB.

4. The mobile device of claim 3, wherein the first of the plurality of electrically small antennas and the second of the plurality of electrically small antenna are configured such that an angle between the first radiation pattern and the second radiation pattern is between about 80 degrees and 100 degrees; and
wherein the first of the plurality of electrically small antennas and the second of the plurality of electrically small antennas have an Envelope Correlation Coefficient (ECC) below 0.5.

5. The mobile device of claim 1, wherein a first of the plurality of electrically small antennas and a second of the plurality of electrically small antennas are both tunable for low-band frequencies between about 600 MHz and 960 MHz.

6. The mobile device of claim 1, comprising a plurality of bandwidth control capacitors wherein each of the plurality of bandwidth control capacitors is connected between one of the plurality of tunable band-stop circuits and the signal node, each of the bandwidth control capacitors having a series capacitance selected to achieve a desired bandwidth within the high-band communications operating frequency range above the band-stop frequency.

7. The mobile device of claim 1, comprising a plurality of resonance control capacitors wherein each of the plurality of resonance control capacitors comprises a first terminal connected between each of the tunable band-stop circuits and the signal node and a second terminal connected to a ground, each of the resonance control capacitors having a shunt capacitance selected to achieve a resonance within the high-band communications operating frequency range above the band-stop frequency.

8. The mobile device of claim 1, wherein a first of the plurality of electrically small antennas is positioned in a first location on the mobile device and a second of the plurality of electrically small antennas is positioned in a second location of the mobile device different from the first location; and
wherein the first location and the second location are selected to optimally minimize antenna coupling and diversity of antenna radiation patterns of the first of the plurality of electrically small antennas and the second of the plurality of electrically small antennas.

9. The mobile device of claim 8, wherein the first location is a first corner of a first edge of the mobile device and the second location is a second corner of the first edge of the mobile device.

10. The mobile device of claim 8, wherein the first of the plurality of electrically small antennas is positioned at a first end of the mobile device and the second of the plurality of electrically small antennas is positioned at a second end of the mobile device, wherein the second end is opposite of the first end.

11. The mobile device of claim 1, wherein the mobile device further comprises a ground plane that is in communication with a first of the plurality of tunable band-stop circuits and a second of the plurality of tunable band-stop circuits; and
wherein the ground plane is positioned between about 4 mm and 10 mm away from the plurality of electrically small antennas.

12. The mobile device of claim 1, wherein each of the plurality of tunable band-stop circuits comprises:
a tunable capacitor connected between a respective one of the plurality of electrically small antennas and the signal node; and
a band-stop inductor connected in parallel with the tunable capacitor between the respective one of the plurality of electrically small antennas and the signal node, the band-stop inductor having an inductance selected to achieve a desired range of band-stop frequencies.

13. The mobile device of claim 12, wherein the tunable capacitor comprises a variable capacitor selected from a group consisting of a micro-electro-mechanical systems (MEMS) variable capacitor, a semiconductor switch-based variable capacitor, a Barium Strontium Titanate (BST) variable capacitor, or a varactor diode.

14. The mobile device of claim 12, wherein the tunable capacitor is tunable to adjust a capacitance of its corresponding band-stop circuit to a range of 2 pF to 5 pF.

15. The mobile device of claim 12, wherein each of the plurality of tunable band-stop circuits comprises a fixed capacitor connected in parallel with the tunable capacitor and the band-stop inductor between each of the plurality of electrically small antennas and the signal node;
wherein a capacitance of the fixed capacitor is selected to achieve a desired minimum capacitance of each of the plurality of tunable band-stop circuits.

16. The mobile device of claim 1, comprising a plurality of reactive circuit elements wherein each of the plurality of reactive circuit elements is coupled between a respective one of the plurality of tunable band-stop circuits and the signal node;
wherein the respective one of the plurality of reactive circuit elements has a reactance selected to achieve a system resonance for a respective one of the plurality of tunable band-stop circuits and the respective one of the electrically small antennas at a desired low-band frequency within the low-band communications operating frequency range below the band-stop frequency.

17. The mobile device of claim 16, wherein each of the plurality of reactive circuit elements comprises an inductor connected in a shunt arrangement with a first terminal of the inductor being connected between one of the tunable band-stop circuits and the signal node and a second terminal of the inductor being connected to a ground.

18. The mobile device of claim 1, comprising one or more capacitors wherein each of the one or more of capacitors is connected between one of the electrically small antennas and a respective one of the plurality of tunable band-stop circuits to pass a radio frequency (RF) signal and provide electrostatic discharge protection.

19. The mobile device of claim 1, further comprising:
a metal ring structure disposed within the mobile device;
wherein a first of the plurality of electrically small antennas comprises a first portion of the metal ring structure;
wherein a second of the plurality of electrically small antennas comprises a second portion of the metal ring structure; and
wherein different parts of the metal ring structure are separated by insulating material.

20. The mobile device of claim 19, wherein the first of the plurality of electrically small antennas and the second of the plurality of electrically small antennas are symmetrically positioned at a first end of the metal ring structure; and
wherein the insulating material is made of plastic and has a length selected to further achieve the desired radiation efficiency of the first of the plurality of electrically small antennas and the second of the plurality of electrically small antennas.

21. The mobile device of claim 20, wherein the insulating material has a length of between about 3 mm and 5 mm.

22. The mobile device of claim 1, further comprising:
a metal ring structure disposed within the mobile device;
wherein the plurality of electrically small antennas comprises four electrically small antennas;
wherein a first of the four electrically small antennas comprises a first portion of the metal ring structure;
wherein a second of the four electrically small antennas comprises a second portion of the metal ring structure;
wherein a third of the four electrically small antennas comprises a third portion of the metal ring structure;
wherein a fourth of the four electrically small antennas comprises a fourth portion of the metal ring structure;
wherein different parts of the metal ring structure are separated by insulating material.

23. The mobile device of claim 22, wherein the first of the four electrically small antennas and the second of the four electrically small antennas are symmetrically positioned at a first end of the metal ring structure;
wherein the third of the four electrically small antennas and the fourth of the four electrically small antennas are symmetrically positioned at a second end of the metal ring structure substantially opposing the first end; and
wherein the insulating material is made of plastic and has a length of at least 3mm.

24. The mobile device of claim 22, wherein the four electrically small antennas are substantially identical in physical structure and electrical performance such that a gain imbalance of the four electrically small antennas is about 0.5 dB or less;
wherein the four electrically small antennas are tunable for low band frequencies between about 600 MHz and 960 MHz;
wherein the first of the four electrically small antennas has a first radiation pattern and the second of the four electrically small antennas has a second radiation pattern;
wherein the third of the four electrically small antennas has a third radiation pattern substantially the same as the second radiation pattern of the second of the four electrically small antennas;
wherein the fourth of the four electrically small antennas has a fourth radiation pattern substantially the same as the first radiation pattern of the first of the four electrically small antennas;
wherein the first of the four electrically small antennas and the second of the four electrically small antennas are configured such that an angle between the first radiation pattern and the second radiation pattern is between about 80 degrees and 100 degrees;
wherein the third of the four electrically small antennas and the fourth of the four electrically small antennas are configured such that an angle between the third radiation pattern and the second radiation pattern is between about 80 degrees and 100 degrees;
wherein the first of the four electrically small antennas and the second of the four electrically small antennas have an Envelope Correlation Coefficient (ECC) below 0.5; and
wherein the third of the four electrically small antennas and the fourth of the four electrically small antennas have an ECC below 0.5.

25. The mobile device of claim 24 wherein the first of the four electrically small antennas and the third of the four electrically small antennas have an ECC of below 0.5; and
wherein the second of the four electrically small antennas and the fourth of the four electrically small antennas have an ECC below 0.5.

26. A method of wireless communication, the method comprising:
arranging a plurality of electrically small antennas on a mobile device;
arranging a plurality of tunable band-stop circuits on the mobile device, wherein each of the plurality of electrically small antennas communicates with at least one tunable band-stop circuit and every tunable band-stop circuit connects to a signal node; and
tuning each of the plurality of electrically small antennas with at least one of the plurality of tunable band-stop circuits to adjust a band-stop frequency that is above a low-band communications operating frequency range and below a high-band communications operating frequency range of the mobile device;
wherein each of the plurality of electrically small antennas has a largest dimension that is substantially equal to or less than one-tenth of a length of a wavelength corresponding to a frequency within the low-band communications operating frequency range that is below the band-stop frequency.

27. The method of claim 26 further comprising:
providing the mobile device with a metal ring structure disposed inside of the mobile device;
using portions of the metal ring structure as antenna radiators for the plurality of electrically small antennas; and
separating portions of the metal ring structure with between about 3 mm and 5 mm of insulating material.

28. The method of claim 26, wherein arranging the plurality of electrically small antennas comprises positioning the plurality of electrically small antennas such that, when the plurality of electrically small antennas is transmitting and receiving wireless signals, there is minimal signal interference between the plurality of electrically small antennas.

29. The method of claim 27, wherein the antenna radiators are identical in shape and size.

30. The method of claim 26 further comprising:
connecting one or more circuits between each of the plurality of electrically small antennas and a ground plane of the mobile device; and
arranging the ground plane of the mobile device between about 4 mm and 10 mm away from each of the plurality of electrically small antennas.

31. The method of claim 26 further comprising arranging each of the plurality of electrically small antennas such that an angle between radiation patterns of the plurality of electrically small antennas is between about 80 degrees and 100 degrees; and
arranging each of the plurality of electrically small antennas such that an ECC between the plurality of electrically small antennas is below 0.5.

32. The method of claim 31 wherein each of the plurality of electrically small antennas are symmetric in physical structure and electrical performance such that a gain imbalance of two of the plurality of electrically small antennas arranged on a same end of the mobile device is about 0.5 dB or less.
